(19) United States
(12) Patent Application Publication
(10) Pub. No.: US 2017/0218975 A1
(43) Pub. Date: Aug. 3, 2017

(54) VARIABLE PITCH FAN BLADE ARRANGEMENT FOR GAS TURBINE ENGINE

(71) Applicant: United Technologies Corporation, Hartford, CT (US)

(72) Inventors: Matthew E. Bintz, West Hartford, CT (US); Frederick M. Schwarz, Glastonbury, CT (US); Yuan Dong, Glastonbury, CT (US)

(21) Appl. No.: 15/009,868

(22) Filed: Jan. 29, 2016

(51) Int. Cl. F04D 29/36; F04D 29/52; F04D 25/02; F04D 29/56; F02K 3/06; F01D 5/02; F04D 25/04; F04D 19/00; F02K 1/72

(52) U.S. Cl. CPC F04D 29/364; F04D 19/002; F04D 29/522; F04D 25/028; F02K 1/72; F02K 3/06; F01D 5/02; F04D 25/045; F04D 29/563; F05D 2220/32; F05D 2240/30; F05D 2260/70; F05D 2260/40311

(57) ABSTRACT

A gas turbine engine according to an example of the present disclosure includes, among other things, a fan including a plurality of fan blades rotatable about an engine axis. Each of the fan blades have a leading edge and rotate about a fan blade axis. A method of operating a gas turbine engine is also disclosed.

### BACKGROUND

This disclosure relates generally to a fan section for gas turbine engines, and more particularly to modulating fan airflow utilizing variable pitch fan blades.

A gas turbine engine typically includes a fan section, a compressor section, a combustor section, and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section.

The fan section includes multiple fan blades disposed circumferentially about an engine longitudinal centerline axis. At certain aircraft operating conditions, these fan blades may experience instability such as stall or flutter. Instability can cause vibration and fracture in the fan blades and other parts of the engine. To avoid instability, fan blades may have to be made thicker or longer, or the blade angle may be altered from optimum for efficiency. These measures result in weight increase or performance debit.

### SUMMARY

A gas turbine engine according to an example of the present disclosure includes a fan including a plurality of fan blades rotatable about an engine axis, a diameter of the fan having a dimension D that is based on a dimension of the fan blades. Each of the fan blades have a leading edge and rotate about a fan blade axis that is substantially transverse to the engine axis. A nacelle assembly is arranged at least partially about the fan. The nacelle assembly includes an inlet portion forward of the fan and a bypass flow path. A length of the inlet portion has a dimension L between a location of the leading edge of at least some of the fan blades and a forward edge on the inlet portion, wherein a dimensional relationship of L/D is less than or equal to about 0.4.

In a further embodiment of any of the foregoing embodiments, the dimensional relationship of L/D is equal to or greater than about 0.24.

In a further embodiment of any of the foregoing embodiments, rotation of each of the fan blades about the corresponding fan blade axis is bounded between a first position and a second position to define a pitch change angle. The first position relating to a first reference plane extends in a radial direction through the engine axis, and the second position relates to a second reference plane perpendicular to the first reference plane.

In a further embodiment of any of the foregoing embodiments, the pitch change angle is less than or equal to 60 degrees.

In a further embodiment of any of the foregoing embodiments, the plurality of fan blades includes a first fan blade and a second fan blade. The first fan blade is rotatable such that an orientation of the first fan blade differs from an orientation of the second fan blade relative to the engine axis.

A further embodiment of any of the foregoing embodiments includes a fixed area fan nozzle in communication with the fan section.

A further embodiment of any of the foregoing embodiments includes a geared architecture driven by a turbine section. The geared architecture is configured to drive the fan at a different speed than the turbine section, and the geared architecture defines a gear reduction ratio greater than or equal to about 2.3.

In a further embodiment of any of the foregoing embodiments, the nacelle assembly includes a thrust reverser configured to selectively communicate a portion of fan bypass airflow from the bypass flow path.

In a further embodiment of any of the foregoing embodiments, the nacelle assembly includes a first nacelle section arranged at least partially about the fan, and a second nacelle section arranged at least partially about a core cowling to define the bypass flow path. The thrust reverser is positioned axially between the first nacelle section and the second nacelle section, and the second nacelle section is moveable relative to the first nacelle section to vary an exit area of the bypass flow path.

In a further embodiment of any of the foregoing embodiments, the nacelle assembly includes a variable area fan nozzle movable relative to the second nacelle section to vary the exit area.

In a further embodiment of any of the foregoing embodiments, the fan includes between 12 and 20 fan blades. The fan is configured to deliver a portion of air into a compressor section and a portion of air into the bypass flow path, and a bypass ratio which is defined as a volume of air passing to the bypass flow path compared to a volume of air passing into the compressor section, is greater than or equal to 12.

In a further embodiment of any of the foregoing embodiments, the fan is configured to define a pressure ratio of between 1.2 and 1.4 at a predefined operating condition.

A gas turbine engine according to an example of the present disclosure includes a fan including a plurality of fan blades rotatable about an engine axis. A root section of each of the fan blades is rotatable about a corresponding fan blade axis to modulate airflow delivered to a bypass flow path. A geared architecture is configured to drive the fan at a different speed than a turbine section. Rotation of each of the fan blades about the corresponding fan blade axis is bounded between a first position and a second position to define a pitch change angle. The fan is configured to generate forward thrust or zero thrust in respective ones of the first and second positions, and the pitch change angle is less than or equal to 60 degrees.

In a further embodiment of any of the foregoing embodiments, the plurality of fan blades include a first set of fan blades and a second set of fan blades. The first set of fan blades are rotatable such that an orientation of each of the first set of fan blades differs from an orientation of each of the second set of fan blades at a predefined operating condition.

In a further embodiment of any of the foregoing embodiments includes a fan nacelle defining the bypass flow path terminating at a trailing edge, and a thrust reverser configured to selectively communicate airflow from the bypass flow path at a location forward of the trailing edge.

A further embodiment of any of the foregoing embodiments includes a variable area fan nozzle movable relative to the fan nacelle to vary an exit area of the bypass flow path.

A method of operating a gas turbine engine according to an example of the present disclosure includes rotating a plurality of fan blades about a common axis at a first speed, rotating at least some of the plurality of fan blades about a corresponding fan blade axis to modulate fan bypass airflow delivered to a bypass duct, rotation of each of the plurality of fan blades about the corresponding fan blade axis being bounded to define a pitch change angle such that the fan blades generate forward thrust or zero thrust for each position relative to the corresponding fan blade axis, and rotating a fan drive turbine at a second, different speed to drive the plurality of fan blades. The plurality of fan blades define a pressure ratio that is less than or equal to 1.4 at a predetermined operating condition.

A further embodiment of any of the foregoing embodiments includes rotating at least one of the plurality of fan blades to a first orientation during a first operating condition such that the first orientation differs from a second orientation of an adjacent one of the plurality of fan blades.

A further embodiment of any of the foregoing embodiments includes rotating the at least one of the plurality of fan blades during a second operating condition to a third orientation that is substantially the same as the second orientation.

A further embodiment of any of the foregoing embodiments includes communicating fan bypass airflow from the bypass duct to generate reverse thrust.

A further embodiment of any of the foregoing embodiments includes moving a first nacelle section relative to a second nacelle section to vary an exit area of the bypass duct.

In a further embodiment of any of the foregoing embodiments, the plurality of fan blades defines a pressure ratio that is equal to or greater than 1.2 at the predetermined operating condition.

In a further embodiment of any of the foregoing embodiments, the pitch change angle is less than or equal to 60 degrees.

A further embodiment of any of the foregoing embodiments includes communicating a portion of fan bypass airflow from the bypass duct to generate an amount of reverse thrust.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a schematic view of an example gas turbine engine.

FIG. 2A is a schematic view of an example nacelle assembly in a deployed position.

FIG. 2B is a schematic view of the example nacelle assembly of FIG. 2A in a stowed position.

FIG. 3A is a partial cross section view of a thrust reverser and a variable area nozzle in stowed positions.

FIG. 3B is a partial cross section view of the thrust reverser of FIG. 3A in the stowed position and the variable area nozzle of FIG. 3A in a deployed position.

FIG. 3C is a partial cross section view of the thrust reverser and the variable area nozzle of FIG. 3A in deployed positions.

FIG. 4 is a perspective view of an example of a fan.

FIG. 5 is a partial cross-sectional view of the fan of FIG. 4.

FIG. 6 is a radial view of adjacent fan blades of the fan of FIG. 4 depicted at several example orientations.

### DETAILED DESCRIPTION

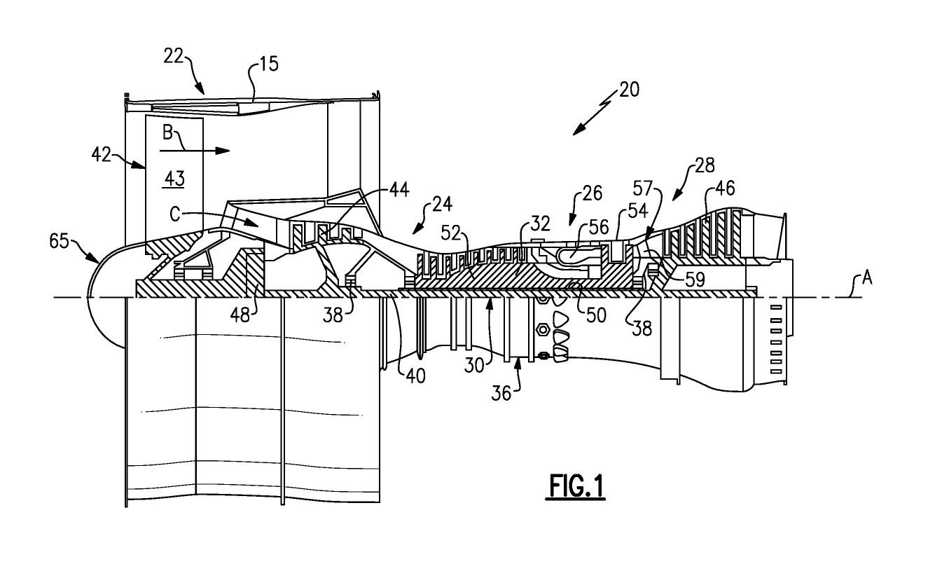

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. In embodiments, the low pressure compressor 44 has between two and eight stages, such as three stages, and has fewer or the same number of stages as the high pressure compressor 52. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6) and less than or equal to about thirty (30), or more narrowly less than or equal to about twenty (20), with an example embodiment being greater than about ten (10), the geared architecture 48 is an epicyclic gear train, such as a planetary gear system or other gear system, with a gear reduction ratio of greater than or equal to about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five (5:1). In a further embodiment, the bypass ratio is greater than or equal to about twelve (12:1). Low pressure turbine 46 pressure ratio is pressure measured prior to inlet of low pressure turbine 46 as related to the pressure at the outlet of the low pressure turbine 46 prior to an exhaust nozzle. In embodiments, the low pressure turbine 46 has between three and six stages, such as five stages, and the high pressure turbine 54 has fewer stages than the low pressure turbine 46, such as one or two stages. The geared architecture 48 may be an epicycle gear train, such as a planetary gear system or other gear system, with a gear reduction ratio of greater than or equal to about 2.3:1, or more narrowly greater than or equal to about 2.5:1. In some embodiments, the gear reduction ratio is less than about 5.0, or less than about 4.0. In further embodiments, the gear reduction ratio is between about 2.4 and about 3.1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.5, or more narrowly less than about 1.45. In some embodiments, the fan pressure ratio is between about 1.2 and about 1.4 at a predefined or predetermined operating condition of the aircraft operating cycle, such as at takeoff or cruise. “Low corrected fan tip speed” is the actual fan tip speed in ft/sec divided by an industry standard temperature correction of [(Tram ° R)/(518.7° R)̂^{0.5}. The “Low corrected fan tip speed” as disclosed herein according to one non-limiting embodiment is less than about 1150 ft/second.

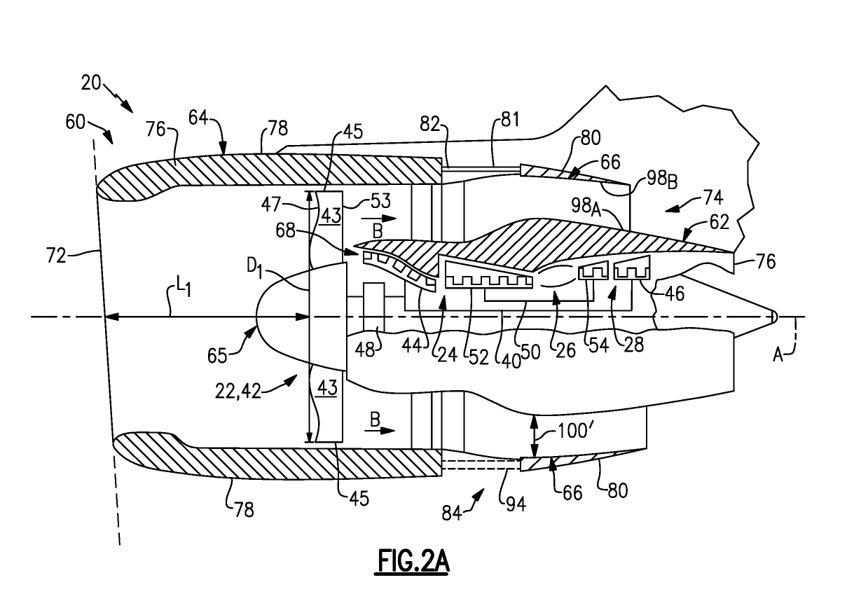

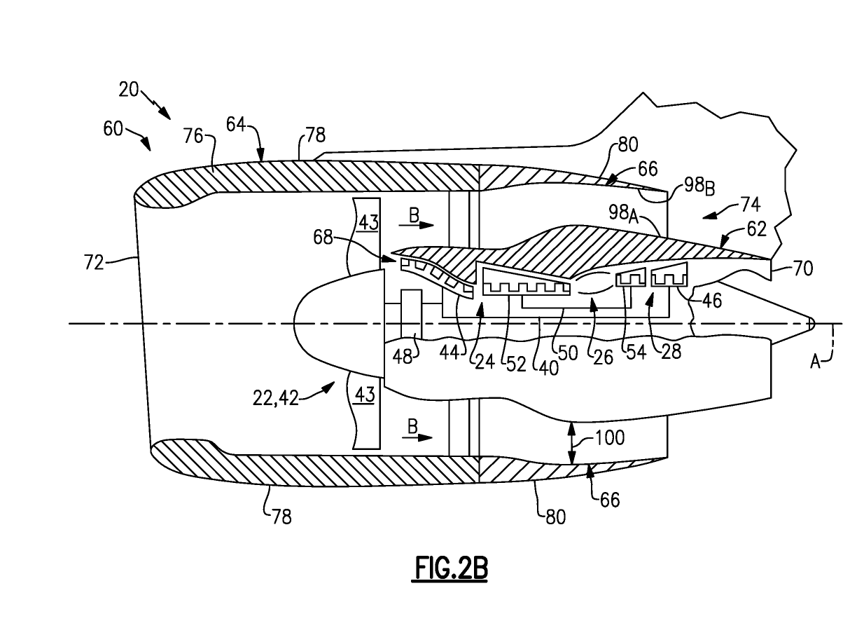

Referring to FIGS. 2A and 2B, a nacelle assembly 60 is shown disposed about the engine axis A. The nacelle assembly 60 includes a core cowling 62, a fan nacelle 64 and a duct 66 defining the bypass flow path B. The core cowling 62 extends circumferentially around and at least partially houses the engine sections 24, 26, 28 and geared architecture 48. The core cowling 62 extends axially along the engine axis A between a core inlet 68 and a core nozzle 70 of the core flow path C downstream of the core inlet 68.

The fan nacelle 64 extends circumferentially around and houses the fan 42 and at least a portion of the core cowling 62, thereby defining the bypass flow path B. The fan nacelle 64 extends axially along the engine axis A between a nacelle inlet 72 and a bypass nozzle 74 of the bypass flow path B downstream of the nacelle inlet 72. An inlet portion 76 of fan nacelle 64 defines the nacelle inlet 72. The inlet portion 76 extends axially between the nacelle inlet 72 and the fan 42. The inlet portion 76 can be configured such that the nacelle inlet 72 is either substantially transverse or substantially perpendicular to the engine axis A.

The nacelle assembly 60 can be configured to have a relatively short inlet portion to improve aerodynamic performance The fan 42 includes a plurality of fan blades 43 each having an airfoil body extending between a leading edge 47 and a trailing edge 53. An axial position of the leading edge 47 of each of the fan blades 43 may be substantially the same or vary at different span or radial positions. The fan blades 43 establish a fan diameter D₁ between circumferentially outermost edges or tips 45 of the fan blades 43 corresponding to leading edges 47. The fan diameter D₁ is shown as a dimension extending between the edges 45 of two of the fan blades 43 that are parallel to each other and extending in opposite directions away from the engine axis A. A length L₁ of the inlet portion 76 is established between nacelle inlet 72 at the engine axis A and an intersection of a plane defining the fan diameter D₁, with the plane being generally perpendicular to the engine axis A.

In embodiments, a dimensional relationship or ratio of L₁/D₁ is less than or equal to about 0.45. In further embodiments, the ratio of L₁/D₁ is equal to or greater than about 0.2, or more narrowly between about 0.24 and about 0.4. For the purposes of this disclosure, the term “about” means ±3 percent unless otherwise stated. Providing a relatively shorter inlet portion 76 facilitates reducing the weight and length of the nacelle assembly 60, and also reduces external drag. Additionally, having a shorter inlet portion 76 can reduce the bending moment and corresponding load on the engine structure during flight conditions.

In some embodiments, the fan nacelle 64 includes a stationary forward (or first) section 78 and an aft (or second) nacelle section 80. The aft nacelle section 80 is moveable relative to the stationary forward section 78, and for example, is configured to selectively translate axially along a supporting structure such as a plurality of guides or tracks 81 (FIG. 2A). In alternative embodiments, the nacelle assembly 60 includes a fixed area fan nozzle such that bypass nozzle 74 is substantially fixed relative to the nacelle inlet 72 or engine axis A and an exit area of the bypass flow path B remains substantially constant.

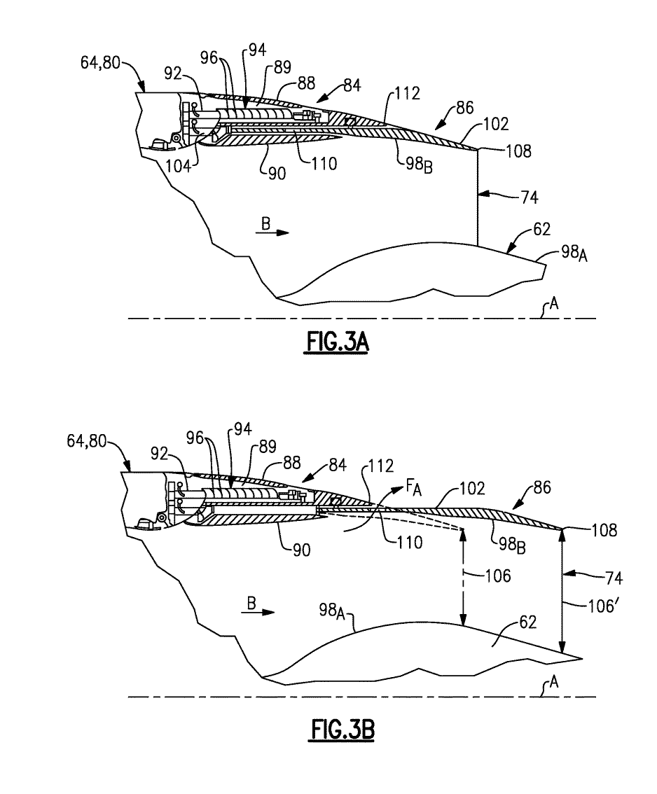

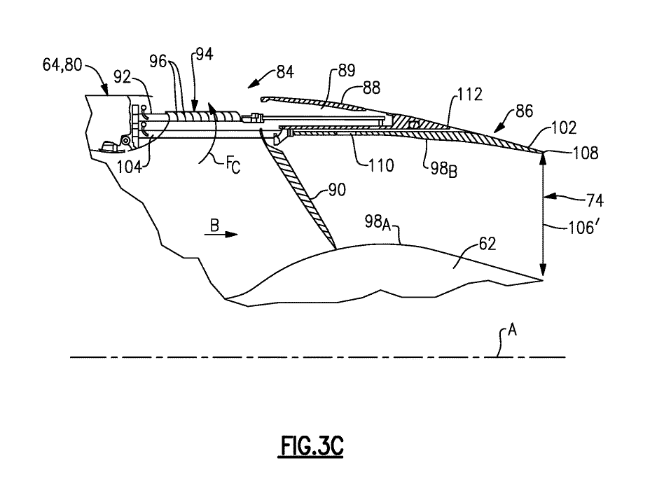

Referring to FIGS. 3A-3C, the nacelle assembly 60 can include a thrust reverser 84 and/or a variable area nozzle 86 for adjusting various characteristics of the bypass flow path B. FIG. 3A illustrates the thrust reverser 84 and the variable area nozzle 86 in stowed positions. FIG. 3B illustrates the thrust reverser 84 in the stowed position and the variable area nozzle 86 in a deployed position. FIG. 3C illustrates the thrust reverser 84 in a deployed position and the variable area nozzle 86 in stowed position.

The thrust reverser 84 includes a thrust reverser body 88, which is configured with the aft nacelle section 80. The thrust reverser 84 can include one or more blocker doors 90, one or more actuators 92, and/or one or more cascades 94 of turning vanes 96 arranged circumferentially around the longitudinal axis A. The thrust reverser body 88 can have a generally tubular or annular geometry with an axially extending slot or channel configured to accommodate a support structure 82 (FIGS. 2A-2B). The thrust reverser body 88 includes at least one recess 89 that houses the cascades 94 and the actuators 92 when the thrust reverser 84 is in the stowed position.

Each blocker door 90 is pivotally connected to the thrust reverser body 88. The actuators 92 are adapted to axially translate the thrust reverser body 88 between the stowed and deployed positions. As the thrust reverser body 88 translates aftwards, the blocker doors 90 pivot radially inward into the bypass flow path B and selectively divert or otherwise communicate at least some or substantially all of the bypass air as flow Fc through the cascades 94 to provide reverse engine thrust. In other embodiments, the cascades 94 are configured to translate axially with a respective thrust reverser body 88. The thrust reverser body 88 and/or cascades 94 can include one or more circumferential segments that synchronously or independently move between deployed and stowed positions.

In alternative embodiments, the thrust reverser 84 is configured without blocker doors. Opposing surfaces 98_{A}, 98_{B} of the core cowling 62 and/or aft nacelle section 80 may include one or more contoured segments to define a radial distance 100 (FIG. 2B). As the aft nacelle section 80 translates aftwards, the radial distance 100 may change (e.g., reduces) to a radial distance 100′ (FIG. 2A) to partially or fully obstruct the bypass flow path B to provide reverse engine thrust by divert flowing through the cascades 94 (shown in dashed lines at the bottom of FIG. 2A).

The variable area nozzle 86 includes a nozzle body 102 and one or more actuators 104. The nozzle body 102 is configured with the aft nacelle section 80, and is arranged radially within and may nest with the thrust reverser body 88. The nozzle body 102 may have a generally tubular or annular geometry with an axially extending slot or channel configured to accommodate the support structure 82 (shown in FIGS. 2A-2B). The actuators 104 are configured to axially translate the nozzle body 102 between the stowed position of FIG. 3A and the deployed position of FIG. 3B. As the nozzle body 102 translates aftwards relative to the engine axis A, a radial distance 106 of the bypass nozzle 74 between a trailing edge or aft end 108 of the fan nacelle 64 and the core cowling 62 may change (e.g., increase) to radial distance 106′ and thereby change (e.g., increase) a flow area of the bypass nozzle 74. In this manner, the variable area nozzle 86 may adjust a pressure drop or ratio across the bypass flow path B by changing the flow area of the bypass nozzle 74.

The variable area nozzle 86 can define or otherwise include at least one auxiliary port 110 to affect the bypass flow. In the illustrated embodiment, the auxiliary port 110 is defined between an upstream portion 112 of the aft nacelle section 80 and the nozzle body 102 of the variable area nozzle 86 as the nozzle body 102 translates axially aftwards relative to the upstream portion 112. Communication of flow F_{A} (FIG. 3B) through a flow area of the auxiliary port 110 increasing an effective flow area of the variable area nozzle 86. The variable area nozzle 86 therefore may adjust a pressure drop or ratio across the bypass flow path B while translating the nozzle body 102 over a relatively smaller axial distance. In alternative embodiments, the variable area nozzle 86 includes one or more bodies (e.g., flaps similar to blocker doors 90) that may move radially and/or axially to change the flow area of the bypass nozzle 74.

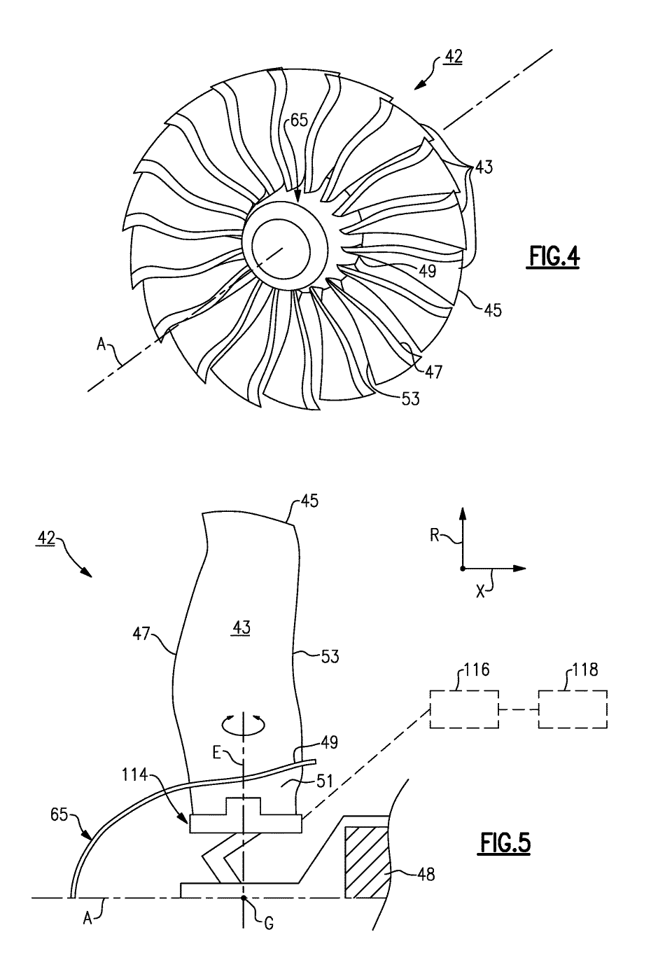

FIG. 4 illustrates fan 42 with a plurality of fan blades 43 which are rotatable about a common axis such as engine axis A. Each of the fan blades 43 extends radially between a platform 49 adjacent conical hub 65 and fan tip 45. In some embodiments, the fan 42 includes 26 or fewer fan blades, or more narrowly 20 or fewer fan blades. In embodiments, the fan 42 includes at least 12 to 14 fan blades. In further embodiments, the fan 42 includes 16 or more fan blades, or more narrowly 18 or more fan blades. It may be desirable to change fan pressure or other flow characteristics of fan 42, by adjusting the fan blades 43 to a desired orientation or angle of attack, due to changes in aircraft velocity and thrust requirements during the engine cycle, such as idle, takeoff, climb, cruise and/or descent.

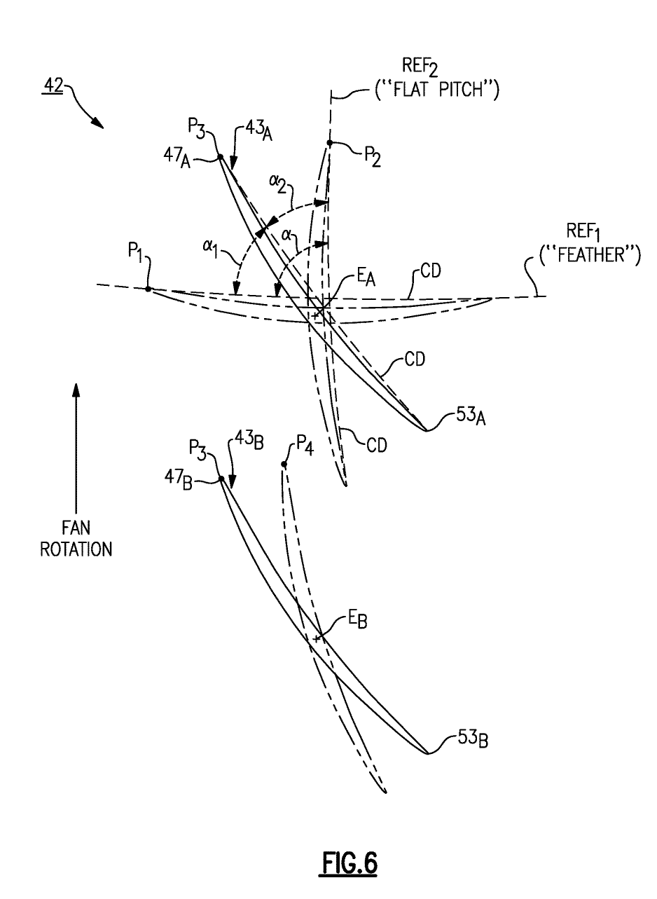

FIG. 5 illustrates a partial cross-sectional view of the fan 42 including a pitch change mechanism 114 for varying a pitch of one or more fan blades 43. Each of the fan blades 43 (one shown for illustrative purposes) is rotatably attached to the hub 65 via the pitch change mechanism 114. The pitch change mechanism 114 is configured to cause one or more of the fan blades 43 to rotate about a corresponding fan blade axis E. The fan blade axis E generally extends in a spanwise or radial direction R between tip 45 and root 51, with the radial direction R being perpendicular to chordwise direction X. The fan blade axis E can be perpendicular, or otherwise transverse to, the engine axis A. In an embodiment, the fan blade axis E of each of the fan blades 43 intersects the engine axis A at substantially the same location marked by intersection point G.

In the illustrated embodiment, a root section 51 of the fan blade 43 is attached to the pitch change mechanism 114 via a thrust bearing, for example, and is configured to allow the fan blade 43 to rotate about the fan blade axis E at the section root 51. The pitch change mechanism 114 includes an actuator 116 coupled to a control device 118 to cause the fan blade 43 to rotate to a desired pitch or angle of incidence. Example actuators and control devices can include a hydraulic pump coupled to a hydraulic source, an electrical motor coupled to a dedicated controller or engine controller, or another suitable device. By changing the pitch of one or more of the fan blades 43, the fan bypass airflow is modulated, and performance of the gas turbine engine 20 is able to be improved over a wider range of operating conditions than only a single aerodynamic design point (ADP), such as during takeoff, climb, cruise, descent, and/or landing.

Referring to FIG. 6, with continued reference to FIG. 5, adjacent fan blades 43_{A} and 43_{B} are depicted at several orientations (shown in dashed lines). Rotation of at least some, or each, of the fan blades 43_{A}, 43_{B} about the corresponding fan blade axis B can be bounded or otherwise limited to provide limited pitch change. As illustrated by fan blades 43_{A}, rotation about the corresponding fan blade axis E_{A} can be bounded between a first position P₁ and a second position P₂ to define a pitch change angle α. The pitch change angle α is defined relative to chord CD extending between leading edge 47_{A} and trailing edge 53_{A} of fan blade 43_{A} for the first and second positions P₁, P₂. The first position P₁ can relate to, or coincide with, a first reference plane REF₁ extending in the radial direction R through the engine axis A (FIG. 5), and the second position P₂ can relate to, or coincide with, a second reference plane REF₂ substantially perpendicular to the first reference plane REF₁. Rotation of fan blade 43_{A} counterclockwise about the fan blade axis E_{A} from a neutral position P₃ (i.e., against rotation of the fan 42 about engine axis A) causes the fan blade 43_{A} to unload and can be utilized to reduce flutter and other aerodynamic instability.

Fan blades 43 can be twisted about a stacking axis extending generally in the radial direction R between tip 45 and platform 49, as illustrated in FIG. 4. In this configuration, a relative orientation of chord CD varies for at least some span positions. The pitch change angle α can be defined as an average value for each span position between the tip 45 and root 49, or can be defined at a single span position such as 0% span at platform 49, mid-span, or 100% span at tip 45.

In embodiments, the fan 42 is configured to generate forward thrust, or substantially no thrust, at each orientation between the first and second positions P₁, P₂. For example, the first position P₁ may be at the first reference plane REF₁ (i.e., “feather” position), and the second position P₂ may be at the second reference plane REF₂ (i.e., “flat pitch” position). In the feather position, fan blade 43_{A} is oriented such that substantially zero thrust is produced or is otherwise limited, and opposes rotation of the fan 42 about the engine axis A. The pitch change mechanism 114 is configured such that fan 42 substantially does not produce reverse thrust at each orientation of the fan blades 43 between the feather and flat pitch positions. In some embodiments, the pitch change mechanism 114 is configured to cause one or more of the fan blades 43 to rotate to the first reference plane REF₁ during a first condition, such as an inflight shutdown (IFSD) event, to reduce drag caused by the fan 42 interacting with oncoming airflow and reduce degradation of the geared architecture 48 otherwise caused by windmilling or rotation of fan 42 when lubrication flow to the geared architecture 48 is reduced below a predetermined threshold, and bound rotation of the fan blades 43 at a position different from the first reference plane REF₁ during a second, different condition such that the fan blades 43 produce forward thrust.

In another embodiment, the first position P1 and/or second position P2 are between, or different from, the first and second reference planes REF₁, REF₂ such that the pitch change angle α is reduced and the fan 42 generates forward thrust at each orientation. In this arrangement, the pitch change mechanism 114 prohibits the leading edge 47_{A} of the fan blade 43_{A} from rotating through the first reference plane REF₁ to produce reverse thrust, thereby reducing a likelihood of fan instability. In one embodiment, rotation is bounded such that the pitch change angle α is less than or equal to 60 degrees, and is also greater than about 20 degrees. In another embodiment, rotation is bounded such that the pitch change angle α is less than or equal to 30 degrees, or more narrow less than or equal to 20 degrees.

The pitch change angle α can have a first portion al and a second portion α₂ defined relative to neutral position P₃ corresponding to a predetermined aerodynamic design point (ADP). The ADP of fan 42 may correspond to the middle of a flight cycle, idle, cruise, or a top of climb, for example. ADP may be set based on a combination of aircraft velocity and angle of attack or geometry of the fan blades 43, for example. However, propulsive efficiency of the fan blades 43 may be reduced at operating conditions other than the ADP.

In one embodiment, each of first and second portions α₁, α₂ of the pitch change angle α is limited to thirty degrees or less, or more narrowly fifteen degrees or less, such that fan blade 43_{A} can rotate in clockwise and/or counterclockwise directions relative to neutral position P₃, thereby permitting optimization of fan performance over different operating conditions. In another embodiment, the first and second portions α₁, α₂ define different relative values such that permitted rotation relative to neutral position P₃ is asymmetrical. For example, the first portion α₁ may be a first quantity less than an angle defined between feather and flat pitch, and the second portion α₁ may be a second, different quantity such that the first and second quantities are less than or equal to the angle between feather and flat pitch. As another example, the first portion α₁ may be less than or equal to about thirty degrees to “open” the fan blade 43_{A}, and the second portion α₁ may be less than or equal to about ten degrees to “close” the fan blade 43_{A} and reduce loading. In general, the limited variable pitch of fan 42 does not compromise the angle of incidence relative to oncoming airflow, and increases laminar flow and efficiency during cruise or other conditions.

The pitch change mechanism 114 can be configured to return the fan blades 43 to a desired default position in the event of a predetermined condition, such as an inflight shutdown (IFSD) event. For example, if hydraulic pressure or electrical signal loss from actuator 116 or control device 118 to the pitch change mechanism 114 does occur, then the pitch change mechanism 114 may cause the fan blades 43 to rotate to one of the first and second positions P₁, P₂, or an intermediate position. In one embodiment, the pitch change mechanism 114 causes rotation or feathering of the fan blades 43 to the first position P₁, which can reduce aerodynamic drag otherwise caused by the fan blades 43.

The pitch change mechanism 114 described herein can also reduce fan distortion and aerodynamic instability relating to the short inlet configuration of nacelle assembly 60 at takeoff or crosswind conditions, for example, by reducing backpressure downstream of the fan 42. For the purposes of this disclosure, the length L₁ corresponds to the forwardmost location of the leading edge 47 relative to each angular position of the fan blade 43, such as at position P₁ or first reference plane REF₁. The variable area fan nozzle 86 can be eliminated from the nacelle assembly 60 because of the ability to reduce or minimize flutter of the fan blades 43 by varying the pitch. In alternative embodiments, the pitch change mechanism 114 is utilized in combination with the thrust reverser 84 and/or variable area fan nozzle 86.

The fan 42 can be configured to provide mistuning of one or more of the fan blades 43 relative to one or more other fan blades 43. For example, the fan 42 can include at least a first set of fan blades 43 and a second set of fan blades 43. The first set of fan blades 43 are rotatable such that the orientation of each of the first set of fan blades 43 differs from the orientation of each the second set of fan blades 43 during a predefined operating condition, such as takeoff or climb. Although FIG. 5 illustrates mistuning of two adjacent fan blades 43A, 43B, the pitch change mechanism 114 can be configured to change the relative orientation of any of the fan blades 43. As seen in FIG. 5, fan blade 43_{A} can be rotated to the first position P₁, and fan blade 43_{B} can be rotated to a fourth position P₄ such that the orientations relative to the engine axis A differ from each other. The pitch change mechanism 114 can be configured to cause the fan blades 43 to return to a substantially common pitch change angle α at ADP, at another predefined or predetermined operating condition including a phase of flight (e.g., takeoff, climb, cruise and/or descent) or a ground operation (e.g., idle or taxi), or upon command, to provide the desired fan performance.

It should be understood that relative positional terms such as “forward,” “aft,” “upper,” “lower,” “above,” “below,” and the like are with reference to the normal operational attitude of the vehicle and should not be considered otherwise limiting.

The foregoing description is exemplary rather than defined by the limitations within. Many modifications and variations of the present invention are possible in light of the above teachings. The disclosed embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A gas turbine engine comprising:
a fan including a plurality of fan blades rotatable about an engine axis, a diameter of the fan having a dimension D that is based on a dimension of the fan blades, each of the fan blades having a leading edge and rotatable about a fan blade axis that is substantially transverse to the engine axis; and
a nacelle assembly arranged at least partially about the fan, the nacelle assembly including an inlet portion forward of the fan and a bypass flow path, a length of the inlet portion having a dimension L between a location of the leading edge of at least some of the fan blades and a forward edge on the inlet portion, wherein a dimensional relationship of L/D is less than or equal to about 0.4.

2. The gas turbine engine as recited in claim 1, wherein the dimensional relationship of L/D is equal to or greater than about 0.24.

3. The gas turbine engine as recited in claim 1, wherein rotation of each of the fan blades about the corresponding fan blade axis is bounded between a first position and a second position to define a pitch change angle, the first position relating to a first reference plane extending in a radial direction through the engine axis, and the second position relating to a second reference plane perpendicular to the first reference plane.

4. The gas turbine engine as recited in claim 3, wherein the pitch change angle is less than or equal to 60 degrees.

5. The gas turbine engine as recited in claim 3, wherein the plurality of fan blades includes a first fan blade and a second fan blade, the first fan blade rotatable such that an orientation of the first fan blade differs from an orientation of the second fan blade relative to the engine axis.

6. The gas turbine engine as recited in claim 3, comprising a fixed area fan nozzle in communication with the fan section.

7. The gas turbine engine as recited in claim 1, comprising a geared architecture driven by a turbine section, the geared architecture configured to drive the fan at a different speed than the turbine section, and the geared architecture defines a gear reduction ratio greater than or equal to about 2.3.

8. The gas turbine engine as recited in claim 1, wherein the nacelle assembly includes a thrust reverser configured to selectively communicate a portion of fan bypass airflow from the bypass flow path.

9. The gas turbine engine as recited in claim 8, wherein the nacelle assembly includes:
a first nacelle section arranged at least partially about the fan;
a second nacelle section arranged at least partially about a core cowling to define the bypass flow path, the thrust reverser being positioned axially between the first nacelle section and the second nacelle section, and the second nacelle section moveable relative to the first nacelle section to vary an exit area of the bypass flow path.

10. The gas turbine engine as recited in claim 9, wherein the nacelle assembly includes a variable area fan nozzle movable relative to the second nacelle section to vary the exit area.

11. The gas turbine engine as recited in claim 9, wherein:
the fan includes between 12 and 20 fan blades;
the fan is configured to deliver a portion of air into a compressor section and a portion of air into the bypass flow path; and
a bypass ratio which is defined as a volume of air passing to the bypass flow path compared to a volume of air passing into the compressor section is greater than or equal to 12.

12. The gas turbine engine as recited in claim 11, wherein the fan is configured to define a pressure ratio of between 1.2 and 1.4 at a predefined operating condition.

13. A gas turbine engine comprising:
a fan including a plurality of fan blades rotatable about an engine axis, a root section of each of the fan blades rotatable about a corresponding fan blade axis to modulate airflow delivered to a bypass flow path;
a geared architecture configured to drive the fan at a different speed than a turbine section; and
wherein rotation of each of the fan blades about the corresponding fan blade axis is bounded between a first position and a second position to define a pitch change angle, the fan being configured to generate forward thrust or zero thrust in respective ones of the first and second positions, and the pitch change angle is less than or equal to 60 degrees.

14. The gas turbine engine as recited in claim 13, wherein the plurality of fan blades include a first set of fan blades and a second set of fan blades, the first set of fan blades rotatable such that an orientation of each of the first set of fan blades differs from an orientation of each of the second set of fan blades at a predefined operating condition.

15. The gas turbine engine as recited in claim 13, comprising:
a fan nacelle defining the bypass flow path terminating at a trailing edge; and
a thrust reverser configured to selectively communicate airflow from the bypass flow path at a location forward of the trailing edge.

16. The gas turbine engine as recited in claim 15, comprising a variable area fan nozzle movable relative to the fan nacelle to vary an exit area of the bypass flow path.

17. A method of operating a gas turbine engine comprising:
rotating a plurality of fan blades about a common axis at a first speed;
rotating at least some of the plurality of fan blades about a corresponding fan blade axis to modulate fan bypass airflow delivered to a bypass duct, rotation of each of the plurality of fan blades about the corresponding fan blade axis being bounded to define a pitch change angle such that the fan blades generate forward thrust or zero thrust for each position relative to the corresponding fan blade axis;
rotating a fan drive turbine at a second, different speed to drive the plurality of fan blades; and
wherein the plurality of fan blades define a pressure ratio that is less than or equal to 1.4 at a predetermined operating condition.

18. The method as recited in claim 17, comprising rotating at least one of the plurality of fan blades to a first orientation during a first operating condition such that the first orientation differs from a second orientation of an adjacent one of the plurality of fan blades.

19. The method as recited in claim 18, comprising rotating the at least one of the plurality of fan blades during a second operating condition to a third orientation that is substantially the same as the second orientation.

20. The method as recited in claim 18, comprising communicating fan bypass airflow from the bypass duct to generate reverse thrust.

21. The method as recited in claim 17, comprising moving a first nacelle section relative to a second nacelle section to vary an exit area of the bypass duct.

22. The method as recited in claim 17, wherein the plurality of fan blades defines a pressure ratio that is equal to or greater than 1.2 at the predetermined operating condition.

23. The method as recited in claim 22, wherein the pitch change angle is less than or equal to 60 degrees.

24. The method as recited in claim 23, comprising communicating a portion of fan bypass airflow from the bypass duct to generate an amount of reverse thrust.
